(19) United States
(12) Patent Application Publication
(10) Pub. No.: US 2014/0267993 A1
(43) Pub. Date: Sep. 18, 2014

(54) LIQUID CRYSTAL DEVICE AND ELECTRONIC APPARATUS

(71) Applicant: Japan Display Inc., Tokyo (JP)

(72) Inventors: Hiroki SUGIYAMA, Tokyo (JP); Takeo KOITO, Tokyo (JP); Hayato KURASAWA, Tokyo (JP)

(73) Assignee: Japan Display Inc., Tokyo (JP)

(21) Appl. No.: 14/198,250

(22) Filed: Mar. 5, 2014

(30) Foreign Application Priority Data
Mar. 18, 2013 (JP) 2013-055544

(51) Int. Cl. G02F 1/1337

(52) U.S. Cl. CPC G02F 1/1337
USPC 349/128

(57) ABSTRACT

According to an aspect, a liquid crystal device includes: a first substrate that is a transparent substrate; a second substrate that is a transparent substrate facing the first substrate; a liquid crystal layer that contains liquid crystal molecules and is provided between the first substrate and the second substrate; a first orientation film that orients the liquid crystal molecules and is provided above a surface on the liquid crystal layer side of the first substrate; and a second orientation film that orients the liquid crystal molecules and is provided above a surface on the liquid crystal layer side of the second substrate. A difference in an amount of angle exists between a pre-tilt angle given by the first orientation film to liquid crystal molecules near the first orientation film and a pre-tilt angle given by the second orientation film to liquid crystal molecules near the second orientation film.

### CROSS REFERENCES TO RELATED APPLICATIONS

The present application claims priority to Japanese Priority Patent Application JP 2013-055544 filed in the Japan Patent Office on Mar. 18, 2013, the entire content of which is hereby incorporated by reference.

### BACKGROUND

1. Technical Field

The present disclosure relates to a liquid crystal device and an electronic apparatus including the same.

2. Description of the Related Art

Liquid crystal display (LCD) devices use liquid crystals of, for example, a vertical orientation (VA) mode. In such a liquid crystal display device, liquid crystal molecules are oriented so that the long axis direction thereof is oriented along a direction orthogonal to a substrate surface when no voltage is applied (in an off state), and the liquid crystal molecules are oriented so as to tilt (incline) according to the amount of the voltage when a voltage is applied (in an on state). This can cause the liquid crystal molecules that have been oriented orthogonal to the substrate surface in the no-voltage application state to tilt in arbitrary directions when the voltage is applied to the liquid crystal layer, and thus can disturb the orientation of the liquid crystal molecules.

Hence, to regulate the direction of the tilt of the liquid crystal molecules, techniques for providing what is called a pre-tilt angle have been developed, in which the liquid crystal molecules are arranged so as to be inclined in a particular direction in advance. For example, Japanese Patent Application Laid-open Publication No. 2002-202509 discloses a technology that uses the same material for upper and lower orientation films with a liquid crystal layer interposed therebetween. Japanese Patent Application Laid-open Publication No. 2012-198351 discloses a technology that forms areas having different pre-tilt angles on the same substrate by light irradiation. Japanese Patent Application Laid-open Publication No. 2012-177784 discloses a technology in which an orientation film contains a compound in which a polymer compound having a crosslinkable functional group or a polymerizable functional group as a side chain is crosslinked or polymerized.

In a variable lens array that divides a parallax between right and left using refractive index of liquid crystals, a gap between a pair of substrates needs to be held at a predetermined value. A liquid crystal layer of the variable lens array is considerably thicker than that of a liquid crystal layer of a normal liquid crystal display panel. The pre-tilt angle is preferably smaller from the viewpoint of optical characteristics and manufacturing process. However, a large gap between the substrates can cause a reverse twist domain, in which the liquid crystal molecules are in the reversed direction or rotated by 360 degrees, by simply reducing the pre-tilt angle given by an anchoring force between the upper and lower ends of the liquid crystal layer. In the variable lens array, the reverse twist domain has arisen after the orientation of the liquid crystals is once disturbed at a high temperature and then an isotropic process is applied at a low temperature to obtain a uniform orientation. The place where the reverse twist domain arose has brought about a problem of defective display, and thus has caused a reduction in yield.

For the foregoing reasons, there is a need for a liquid crystal device and an electronic apparatus that can eliminate the problem caused by the reverse twist domain, and can suppress the reduction in yield.

### SUMMARY

According to an aspect, a liquid crystal device includes: a first substrate that is a transparent substrate; a second substrate that is a transparent substrate facing the first substrate; a liquid crystal layer that contains liquid crystal molecules and is provided between the first substrate and the second substrate; a first orientation film that orients the liquid crystal molecules and is provided above a surface on the liquid crystal layer side of the first substrate; and a second orientation film that orients the liquid crystal molecules and is provided above a surface on the liquid crystal layer side of the second substrate. A difference in an amount of angle exists between a pre-tilt angle given by the first orientation film to liquid crystal molecules near the first orientation film and a pre-tilt angle given by the second orientation film to liquid crystal molecules near the second orientation film.

According to another aspect, an electronic apparatus includes the liquid crystal device.

Additional features and advantages are described herein, and will be apparent from the following Detailed Description and the figures.

### BRIEF DESCRIPTION OF THE FIGURES

FIG. 1 is a schematic perspective view of an image display device used in an embodiment of the present disclosure in a virtually disassembled state;

FIG. 2 is a schematic plan view of a front side of a variable lens array;

FIG. 3 is a schematic plan view of a back side of the variable lens array;

FIG. 4 is an A-A line sectional view of FIG. 2;

FIG. 5 is a schematic diagram illustrating pre-tilt angles of liquid crystal molecules;

FIG. 6 is a sectional view illustrating a schematic sectional structure of a liquid crystal display panel according to a modification of the embodiment;

FIG. 7 is a diagram illustrating an example of an electronic apparatus to which the image display device according to the embodiment is applied;

FIG. 8 is a diagram illustrating an example of an electronic apparatus to which the image display device according to the embodiment is applied;

FIG. 9 is a diagram illustrating an example of an electronic apparatus to which the image display device according to the embodiment is applied;

FIG. 10 is a diagram illustrating an example of an electronic apparatus to which the image display device according to the embodiment is applied;

FIG. 11 is a diagram illustrating an example of an electronic apparatus to which the image display device according to the embodiment is applied;

FIG. 12 is a diagram illustrating an example of an electronic apparatus to which the image display device according to the embodiment is applied;

FIG. 13 is a diagram illustrating an example of an electronic apparatus to which the image display device according to the embodiment is applied;

FIG. 14 is a diagram illustrating an example of an electronic apparatus to which the image display device according to the embodiment is applied;

FIG. 15 is a diagram illustrating an example of an electronic apparatus to which the image display device according to the embodiment is applied;

FIG. 16 is a diagram illustrating an example of an electronic apparatus to which the image display device according to the embodiment is applied;

FIG. 17 is a diagram illustrating an example of an electronic apparatus to which the image display device according to the embodiment is applied;

FIG. 18 is a diagram illustrating an example of an electronic apparatus to which the image display device according to the embodiment is applied; and

FIG. 19 is a diagram illustrating an example of an electronic apparatus to which the image display device according to the embodiment is applied.

### DETAILED DESCRIPTION

The present disclosure will be described below based on an embodiment with reference to the accompanying drawings. The present disclosure is not limited to the embodiment, and various numerical values and materials in the embodiment are examples. In the description given below, the same numerals will be used for the same elements or those having the same functions, and duplicate description thereof will be omitted. The description will be made in the following order.

1-1. Embodiment

1-2. Modification

2. Application examples

Examples in which an image display device according to the embodiment is applied to an electronic apparatus

3. Aspects of present disclosure

### 1-1. EMBODIMENT

In a variable lens array of the present disclosure or a variable lens array used in the image display device of the present disclosure (hereinafter, they may be simply called a variable lens array of the present disclosure), wall-like or column-like spacers are provided at places where an orientation direction of liquid crystal molecules of a liquid crystal layer remains unchanged when a refractive index of a lens column is changed, as will be described later. The expression “an orientation direction of liquid crystal molecules remains unchanged” includes a case in which the orientation direction of the liquid crystal molecules remains precisely unchanged and also a case in which the orientation direction thereof remains substantially unchanged. In other words, various variations caused by design and/or manufacturing reasons are allowed to exist.

When a use situation is expected in which an image observer presses a surface of the variable lens array, the wall-like spacers are preferably used for ensuring what is called surface pressure strength. Otherwise, it is preferable to arrange the column-like spacers in a number sufficient to ensure enough surface pressure strength. Examples of the shape of the column-like spacers include, but are not limited to, prismatic and cylindrical. Spherical spacers dispersed between the substrates may be used for holding the gap.

A first electrode in a first substrate and a second electrode in a second substrate only need to have each an appropriately preferable planar shape in accordance with the design of the variable lens array. For example, one of the first and the second electrodes may be a planar common electrode whereas the other may be a stripe-shaped electrode, or both may be stripe-shaped. Continuous application of a direct-current voltage to the liquid crystal layer can cause deterioration of liquid crystal material. This can be dealt with by driving the variable lens array so as to sequentially invert the polarity of the voltage between the first and the second electrodes in the same manner as a normal liquid crystal display panel. In addition, the other electrode may be patterned as a planar electrode or a stripe-shaped electrode. Stripes in a parallel direction provide a normal liquid crystal lens, and stripes in orthogonal directions provide a variable lens suitable for 3D observation.

Depending on the design of the first and the second electrodes and on the setting of voltages applied thereto, the variable lens array of the present disclosure including the above-described preferable configuration can have a configuration in which the wall-like or column-like spacers are arranged at central portions of the lens columns. The wall-like or column-like spacers may also be arranged at boundary portions between the respective adjacent lens columns.

From the viewpoint of ensuring flowability of the liquid crystal material, the variable lens array of the present disclosure including the above-described preferable configuration is preferably provided with a gap between ends of the wall-like or column-like spacers and a sealing unit. An outer circumferential portion of the first substrate and an outer circumferential portion of the second substrate are sealed by the sealing unit.

The first and the second substrates constituting the variable lens array can use a material having high optical transmittance. Materials such as an acrylic resin, a polycarbonate (PC) resin, an ABS resin, polymethylmethacrylate (PMMA), a polyallylate resin (PAR), a polyethylene terephthalate (PET) resin, and glass can be examples of materials constituting the first and the second substrates. The materials constituting the first and the second substrates may be the same as or different from each other.

The first electrode of the first substrate and the second electrode of the second substrate can be composed of a transparent conductive material such as a metallic thin film having optical transparency, indium tin oxide (ITO), or indium zinc oxide (IZO). The first and the second electrodes can be formed into films by methods, such as physical vapor deposition (PVD) methods, including a vacuum evaporation method and a sputtering method, and various chemical vapor deposition (CVD) methods. The first and the second electrodes can be patterned by known methods, such as a combination of a photolithographic method and an etching method, and a lift-off method.

A widely known material such as a nematic liquid crystal material can be used as a material constituting the liquid crystal layer arranged between the first and the second substrates. The material constituting the liquid crystal layer is not limited.

Alignment processing for setting the orientation direction and pre-tilt angles of the liquid crystal molecules is applied to surfaces on the liquid crystal layer side of the first and the second substrates. The orientation processing can be performed by a method of, for example, forming an orientation film treated with rubbing treatment. The orientation film can use materials such as a polyimide material.

Examples of the formation method of the wall-like or column-like spacers include, but are not limited to, a screen printing method and an exposure method. The screen printing method is as follows: Openings are formed at portions of a screen corresponding to portions to be formed with the spacers; a material for forming spacer on the screen surface is passed through the openings using a squeegee to form a spacer forming material layer on the substrate; and then, hardening treatment is applied to the spacer forming material layer as needed. The exposure method is a method in which a photosensitive spacer forming material layer is formed on the substrate, and patterned by exposure and development. The spacers can be composed of a known material such as a transparent polymer material.

The sealing unit that seals the portion between the outer circumferential portion of the first substrate and the outer circumferential portion of the second substrate can be composed of a known sealing material such as a thermoset epoxy resin material.

An image display unit used in the image display device of the present disclosure can use a widely known image display device, such as the liquid crystal display panel, an electroluminescence display panel, or a plasma display panel. The image display unit may display a monochromatic image or a color image.

The present embodiment uses a transmissive monochromatic liquid crystal display panel as the image display unit. In the embodiment described, the variable lens array is arranged between the image display unit and the image observer. The structure of the present disclosure is not limited to this. The variable lens array can be arranged between the transmissive display panel and an illumination unit.

The liquid crystal display panel is composed of, for example, a front panel including a transparent common electrode, a rear panel including transparent pixel electrodes, and a liquid crystal material interposed between the front panel and the rear panel. Examples of the drive mode of the liquid crystal display panel include, but are not limited to, what is called the TN mode, the VA mode, and the IPS mode.

A widely known illumination unit can be used as the illumination unit that irradiates the transmissive display panel from the back side. Examples of the illumination unit include, but are not limited to, a light source, a prism sheet, a diffusion sheet, and a light guide plate.

A drive circuit for driving the image display unit and a drive circuit for driving the variable lens array include various circuits. The various circuits include various circuit elements.

Various conditions illustrated in the present application will be satisfied when precisely satisfied and also when substantially satisfied. Various variations caused by design and/or manufacturing reasons are allowed to exist.

FIG. 1 is a schematic perspective view of the image display device used in the embodiment in a virtually disassembled state. As illustrated in FIG. 1, this image display device 1 includes an image display unit 10 that displays a two-dimensional image, an illumination unit 20, and a variable lens array 30. Reference numeral 138 represents a sealing unit between a first substrate 130A and a second substrate 130B.

The variable lens array 30 includes the first substrate 130A, the second substrate 130B, and a liquid crystal layer 137 interposed between the first and the second substrates 130A and 130B (refer to FIG. 4). The variable lens array 30 is disposed so as to face the front side of the image display unit 10, and is held by a holding member (not illustrated) so as to face the image display unit 10 with a predetermined space therebetween defined by the design. The front side of the image display unit 10 refers to the side of the image observer who observes the image displayed by the image display unit 10. As will be described later, between the first and the second substrates 130A and 130B of the variable lens array 30, the wall-like spacers are provided at the places where the orientation direction of the liquid crystal molecules of the liquid crystal layer remains unchanged when the refractive index of a lens column 31 is changed. The present embodiment arranges the wall-like spacers at the central portions of the lens columns 31.

The illumination unit 20 for emitting light is disposed on the back side of the image display unit 10. The illumination unit 20 includes members such as the light source, the prism sheet, the diffusion sheet, and the light guide plate (which are not illustrated).

The image display unit 10 is driven by the drive circuit (not illustrated), and controls the orientation directions of the liquid crystal molecules in pixels to display a two-dimensional image corresponding to a video signal from the outside. The other drive circuit (not illustrated) drives the variable lens array 30, in which the refractive index of the lens column 31 is set to a predetermined value in each of a case of displaying a three-dimensional image and a case of displaying a normal image.

In a display area 11 of the image display unit 10, pixels 12 are arranged in such a manner that M pixels are arranged in the X-direction indicated in FIG. 1 and N pixels are arranged in the Y-direction indicated in FIG. 1. The pixels 12 in the m-th column (where m=1, 2, . . . , M) are represented as pixels 12ₘ.

In the variable lens array 30, the lens columns (variable lens columns) 31 extending in the Y-direction indicated in FIG. 1 are arranged in such a manner that P columns are juxtaposed in the X-direction indicated in FIG. 1. The lens column 31 in the p-th column (where p=1, 2, . . . , P) is represented as a lens column 31ₚ. The relation between “P” and the above-mentioned “M” will be described later.

For convenience of description, the number of viewpoints of images will be described as four, that is, viewpoints A₁, A₂, . . . , A₄ in a central observation area WA_{C}. However, this is merely an example. The number of observation areas and the number of viewpoints can be appropriately set according to the design of the image display device 1. Preferable setting of, for example, positional relations between the image display device 1 and the lens columns 31 allows the image for each of the viewpoints to be observed in an area WA_{L} on the left side and an area WA_{R} on the right side of the central observation area WA_{C}. The variable lens array 30 will be described below with reference to FIGS. 2 to 4.

FIG. 2 is a schematic plan view of the front side of the variable lens array. FIG. 2 illustrates the second substrate 130B with parts thereof cut off. FIG. 3 is a schematic plan view of the back side of the variable lens array. FIG. 3 illustrates the first substrate 130A with parts thereof cut off. FIG. 4 is an A-A line sectional view of FIG. 2.

As illustrated in FIG. 4, the variable lens array 30 serving as a liquid crystal device includes the lens columns 31 whose refractive indices are each changed by changing the orientation directions of the liquid crystal molecules of the liquid crystal layer 137 by the voltage applied between a first electrode 131 and a second electrode 134. The variable lens array 30 includes the first substrate 130A including the first electrodes 131₁, 131₂, . . . , 131₈, the second substrate 130B including the second electrode 134, and the liquid crystal layer 137 interposed between the first and the second substrates 130A and 130B. The first electrodes 131₁, 131₂, . . . , 131₈ may be collectively denoted as the first electrodes 131. The same applies to other elements.

The first electrodes 131 and the second electrode 134 are formed on surfaces (inner surfaces) on the liquid crystal layer 137 side of the first and the second substrates 130A and 130B, respectively. The liquid crystal layer 137 is composed of positive nematic liquid crystal material.

The first electrodes 131 and the second electrode 134 are formed of the transparent conductive material such as the ITO, and formed by film formation. The first electrodes 131 are formed by patterning into a predetermined stripe shape illustrated in FIG. 2. The second electrode 134 is what is called a common electrode, and is formed on the entire surface of the second substrate 130B. For convenience of illustration, FIG. 3 omits display of the second electrode 134 and a second orientation film 135 (to be described later). FIG. 2 also omits display of a first orientation film 133 (to be described later).

As illustrated in FIG. 4, the first orientation film 133 covering the entire surface including the first electrodes 131 is formed on the first substrate 130A, and the second orientation film 135 covering the entire surface including the second electrode 134 is formed on the second substrate 130B. These orientation films are formed of, for example, the polyimide material, and have surfaces treated with the rubbing treatment. The first and the second orientation films 133 and 135 define directions of molecular axes of liquid crystal molecules 137A in a state in which no electric field is applied. The first and the second orientation films 133 and 135 have been subjected to the orientation processing so as to orient the long axis of the liquid crystal molecules 137A in the Y-direction when no electric field is applied, and tilt the long axis toward the Z-direction when an electric field is applied. FIG. 4 illustrates the orientation of the liquid crystal molecules 137A when no electric field is applied. A predetermined voltage is applied from the drive circuit (not illustrated) to the second electrode 134.

FIG. 5 is a schematic diagram illustrating the pre-tilt angles of the liquid crystal molecules. As illustrated in FIG. 5, the first orientation film 133 is formed with grooves 133A by the orientation processing. The grooves 133A give liquid crystal molecules 137AA near the first orientation film 133 a pre-tilt angle of inclination at an angle θ₁ with respect to the surface of the first substrate 130A. The second orientation film 135 is formed with grooves 135A by the orientation processing. The grooves 135A give liquid crystal molecules 137AB near the second orientation film 135 a pre-tilt angle of inclination at an angle θ₂ with respect to the surface of the second substrate 130B.

Setting appropriate rubbing strength during the orientation processing for the variable lens array 30 causes the liquid crystal molecules 137AA near the first orientation film 133 to have a larger pre-tilt angle than the liquid crystal molecules 137AB near the second orientation film 135. In this manner, the first orientation film 133 sets the pre-tilt angle of the liquid crystal molecules 137AA existing in the vicinity thereof larger than that set by the second orientation film 135. Specifically, the angle θ₁ for the pre-tilt angle of the first orientation film 133 and the angle θ₂ for the pre-tilt angle of the second orientation film 135 satisfy: θ₁>θ₂.

In other words, there is a difference in the amount of angle between the pre-tilt angle given by the first orientation film 133 to the liquid crystal molecules 137AA near the first orientation film 133 and the pre-tilt angle given by the second orientation film 135 to the liquid crystal molecules 137AB near the second orientation film 135. The pre-tilt angle changes according to the strength during the orientation processing and also to material characteristics of the orientation films. Therefore, the strength during the orientation processing and the material of the orientation films are appropriately determined.

Suppose that the pre-tilt angle of the liquid crystal molecules 137AA given by the first orientation film 133 and the pre-tilt angle of the liquid crystal molecules 137AB given by the second orientation film 135 are simply increased. While this can suppress the generation of the reverse twist domain, this can affect the optical characteristics and the manufacturing process. In contrast, in the variable lens array 30 according to the present embodiment, increasing only the pre-tilt angle of the liquid crystal molecules 137AA by the first orientation film 133 can suppress the generation of the reverse twist domain without affecting the optical characteristics and the manufacturing process.

This is more effective when the gap between the first and the second substrates 130A and 130B is as large as 10 μm or more, in which case the reverse twist domain is likely to be generated. Increasing the difference between the pre-tilt angles of the first and the second substrates 130A and 130B to three degrees or more can further suppress the generation of the reverse twist domain. The pre-tilt angle of the second orientation film 135 may be larger than the pre-tilt angle of the first orientation film 133.

Each of the lens columns 31 basically corresponds to four columns of the pixels 12. Where pitches of the lens columns 31 and the pixels 12 in the X-direction indicated in FIG. 1 are denoted by symbols LD and ND, respectively, the following relations hold: LD≈4×ND in the case of four-viewpoint 3D, and LD≈2×ND in the case of two-viewpoint 3D. For example, a value of 0.3 mm of the pixel pitch ND gives a value of approximately 1.2 mm of the pitch of the lens columns 31. The above-mentioned “P” and “M” satisfy: P≈M/4.

As illustrated in FIGS. 2 and 4, the stripe-shaped first electrodes 131₁, 131₂, . . . , 131₈ extending in the Y-direction indicated in FIGS. 2 and 4 are arranged in each of the lens columns 31. As illustrated in FIG. 4, the first electrodes 131 are arranged so as to be juxtaposed in the X-direction with predetermined spaces NW therebetween. A symbol EW represents a width in the X-direction of the first electrodes 131. The lens column pitch LD, the space NW, and the width EW satisfy: LD=8×(NW+EW). The number of the first electrodes 131 corresponding to each of the lens columns 31 is not limited to eight, but can be changed appropriately depending on the design of the variable lens array 30. The values of the space NW and the width EW are not limited, but only need to be preferable values as appropriate, taking technologies for the film formation and the patterning into account, for example. While, in the present embodiment, the second electrode 134 is a planar electrode formed on the entire surface of the second substrate 130B, existence of at least one electrode between the adjacent lens columns 31 can form the lens columns 31. This frees the second electrode 134 from the necessity of being formed on the entire surface of the second substrate 130B, provided that at least one electrode is formed between the adjacent lens columns 31. When the second electrode 134 has a stripe shape, the second electrode 134 can be formed in a direction orthogonal to the direction in which the first electrodes 131 extend. This structure achieves the variable lens suitable for the 3D observation, as described above. The second electrode 134 may be formed in a direction parallel to the direction in which the first electrodes 131 extend.

As illustrated in FIG. 2, power supply lines 132₁, 132₂, . . . , 132₄ extending in the X-direction indicated in FIG. 2 are also provided on the surface of the first substrate 130A. The power supply lines 132₁ to 132₄ are also formed basically by the same manufacturing process as that of the first electrodes 131. The first electrodes 131₁ and 131₈ are coupled to the power supply line 132₁, and the first electrodes 131₂ and 131₇ are coupled to the power supply line 132₂. The first electrodes 131₃ and 131₆ are coupled to the power supply line 132₃, and the first electrodes 131₄ and 131₅ are coupled to the power supply line 132₄. FIG. 2 omits illustration of contacts between the power supply lines 132 and the first electrodes 131.

As is clear from the above-described relations of connections, a voltage applied to the power supply line 132₁ controls a voltage of the first electrodes 131₁ and 131₈, and a voltage applied to the power supply line 132₂ controls a voltage of the first electrodes 131₂ and 131₇. A voltage applied to the power supply line 132₃ controls a voltage of the first electrodes 131₃ and 131₆, and a voltage applied to the power supply line 132₄ controls a voltage of the first electrodes 131₄ and 131₅. The drive circuit (not illustrated) applies independent voltages to the respective power supply lines 132₁, 132₂, . . . , 132₄.

As illustrated in FIGS. 3 and 4, wall-like spacers 136 each extending in each of the lens columns 31 are arranged. The spacers 136 are provided at predetermined places on the second orientation film 135 of the second substrate 130B. The spacers 136 are composed of the transparent polymer material, and formed by exposure and development of the photosensitive spacer forming material layer provided on the second orientation film 135.

In the present embodiment, the spacers 136 are provided on the surface of the second orientation film 135 positioned at the central portions of the lens columns 31. With respect to a line passing the center of the spacer 136, the first electrodes 131₁ and 131₈ are symmetrically arranged, and the first electrodes 131₂ and 131₇ are symmetrically arranged. So are the other first electrodes.

In FIG. 4, a symbol SW represents a width in the X-direction indicated in FIG. 4 of the spacer 136. A symbol SH represents a height in the Z-direction indicated in FIG. 4 of the spacer 136. The width SW is, for example, 25 μm, and the height SH is, for example, 50 μm. As illustrated in FIGS. 1 to 3, the outer circumferential portion of the first substrate 130A and the outer circumferential portion of the second substrate 130B are sealed by the sealing unit 138 composed of, for example, the epoxy resin material. A length SL of the spacer 136 illustrated in FIG. 3 is set to a value that provides spaces D1 and D2 between ends of the spacer 136 and the sealing unit 138. The spaces D1 and D2 have values that allow the liquid crystal material to flow between the substrates without difficulty during the manufacturing of the variable lens array 30.

A manufacturing method of the variable lens array 30 will be described. The first electrodes 131, the first to the fourth power supply lines, the first orientation film 133, etc. are appropriately formed on the first substrate 130A. The second electrode 134, the second orientation film 135, the spacers 136, etc. are appropriately formed on the surface of the second substrate 130B. The first and the second substrates 130A and 130B that have undergone the above-described processes are put facing each other with the liquid crystal material interposed therebetween, and are sealed at the circumferences thereof. Thus, the variable lens array 30 can be obtained.

The present embodiment has been described above. The first orientation film 133 of the first substrate 130A is formed with the power supply lines 132 that apply the electric field to the liquid crystal molecules 137A for giving a curvature to the lens columns 31, whereas the second orientation film 135 of the second substrate 130B is not formed with the power supply lines 132. The pre-tilt angle of the first orientation film 133 may be larger than the pre-tilt angle of the second orientation film 135. This achieves better optical characteristics.

### 1-2. MODIFICATION

As a modification of the above-described image display device 1 according to the embodiment, a liquid crystal display panel can be provided instead of the variable lens array 30 and the image display unit 10. FIG. 6 is a sectional view illustrating a schematic sectional structure of the liquid crystal display panel according to the modification. As illustrated in FIG. 6, a display area unit 221 of this liquid crystal display panel 200 serving as a liquid crystal device includes a pixel substrate 221A, a counter substrate 221B disposed so as to face a surface of the pixel substrate 221A in a direction orthogonal thereto, and a liquid crystal layer 221C interposed between the pixel substrate 221A and the counter substrate 221B. In the liquid crystal display panel 200, the distance between the pixel substrate 221A and the counter substrate 221B is, for example, 3 μm to 4 μm.

The liquid crystal layer 221C modulates light passing therethrough according to the state of an electric field, and uses liquid crystals of any of various modes, such as a twisted nematic (TN) mode, a vertical orientation (VA) mode, an electrically controlled birefringence (ECB) mode, and a fringe field switching (FFS) mode.

The counter substrate 221B includes a glass substrate 275 and a color filter 276 formed on one surface of the glass substrate 275. A polarizing plate 273A is provided on the other surface of the glass substrate 275. The color filter 276 includes color regions colored in three colors of red (R), green (G), and blue (B). In the color filter 276, for example, the color regions of the color filter colored in the three colors of red (R), green (G), and blue (B) are periodically arranged, and one set of the color regions of the three colors of R, G, and B is associated with each pixel as a pixel. The color filter 276 faces the liquid crystal layer 221C in a direction orthogonal to a TFT substrate 271. The color filter 276 may have a combination of other colors as long as being colored in different colors from each other. In the color filter 176, the color region of green (G) generally has a higher luminance value than those of the color regions of red (R) and blue (B). A common electrode COML is a transparent electrode formed of the transparent conductive material (transparent conductive oxide) such as the ITO.

The pixel substrate 221A includes the TFT substrate 271 as a circuit substrate, a plurality of pixel electrodes 272 arranged in a matrix on top of the TFT substrate 271, the common electrode COML formed between the TFT substrate 271 and the pixel electrodes 272, an insulation layer 274 insulating the pixel electrodes 272 from the common electrode COML, and an incident-side polarizing plate 273B on the lower surface of the TFT substrate 271.

A first orientation film 277 is interposed between the liquid crystal layer 221C and the pixel substrate 221A. A second orientation film 278 is interposed between the liquid crystal layer 221C and the counter substrate 221B. In the liquid crystal display panel 200 of the modification, the first orientation film 277 gives liquid crystal molecules 221CA a larger pre-tilt angle than a pre-tilt angle of liquid crystal molecules 221CB given by the second orientation film 278.

### 2. APPLICATION EXAMPLES

With reference to FIGS. 7 to 19, a description will be made of application examples of the image display device 1 described in the embodiment and the modification thereof. FIGS. 7 to 19 are diagrams illustrating examples of electronic apparatuses to which the image display device according to the present embodiment is applied. The image display device 1 according to the embodiment or the modification thereof can be applied to electronic apparatuses of all fields, such as television devices, digital cameras, notebook type personal computers, portable electronic apparatuses including mobile phones, and video cameras. In other words, the image display device 1 according to the embodiment or the modification thereof can be applied to electronic apparatuses of all fields that display externally received video signals or internally generated video signals as images or video pictures.

### Application Example 1

The electronic apparatus illustrated in FIG. 7 is a television device to which the image display device 1 according to the embodiment or the modification thereof is applied. This television device includes, for example, a video display screen unit 510 that includes a front panel 511 and a filter glass 512. The video display screen unit 510 is the image display device 1 according to the embodiment or the modification thereof.

### Application Example 2

The electronic apparatus illustrated in FIGS. 8 and 9 is a digital camera to which the image display device 1 according to the embodiment or the modification thereof is applied. This digital camera includes, for example, a light-emitting unit 521 for flash, a display unit 522, a menu switch 523, and a shutter button 524. The display unit 522 is the image display device 1 according to the embodiment or the modification thereof.

### Application Example 3

The electronic apparatus illustrated in FIG. 10 represents an external appearance of a video camera to which the image display device 1 according to the embodiment or the modification thereof is applied. This video camera includes, for example, a body 531, a lens 532 for taking a subject provided on the front side face of the body 531, and a start/stop switch 533 and a display unit 534 used during taking of a picture. The display unit 534 is the image display device 1 according to the embodiment or the modification thereof.

### Application Example 4

The electronic apparatus illustrated in FIG. 11 is a notebook type personal computer to which the image display device 1 according to the embodiment or the modification thereof is applied. This notebook type personal computer includes, for example, a body 541, a keyboard 542 for input operation of characters, etc., and a display unit 543 that displays images. The display unit 543 is the image display device 1 according to the embodiment or the modification thereof.

### Application Example 5

The electronic apparatus illustrated in FIGS. 12 to 18 is a mobile phone to which the image display device 1 according to the embodiment or the modification thereof is applied. This mobile phone is, for example, composed of an upper housing 551 and a lower housing 552 connected to each other by a connection unit (hinge unit) 553, and includes a display 554, a subdisplay 555, a picture light 556, and a camera 557. The display 554 and/or the subdisplay 555 are each the image display device according to the embodiment or the modification thereof.

### Application Example 6

The electronic apparatus illustrated in FIG. 19 is a portable information terminal that operates as a portable computer, a multifunctional mobile phone, a portable computer with voice call capability, or a portable computer with communication capability, and that is sometimes called a smartphone or a tablet computer. This portable information terminal includes, for example, a display unit 562 on a surface of a housing 561. The display unit 562 is the image display device 1 according to the embodiment or the modification thereof.

### 3. ASPECTS OF PRESENT DISCLOSURE

The present disclosure includes the following aspects.

(1) A liquid crystal device comprising:

a first substrate that is a transparent substrate;

a second substrate that is a transparent substrate facing the first substrate;

a liquid crystal layer that contains liquid crystal molecules and is provided between the first substrate and the second substrate;

a first orientation film that orients the liquid crystal molecules and is provided above a surface on the liquid crystal layer side of the first substrate; and

a second orientation film that orients the liquid crystal molecules and is provided above a surface on the liquid crystal layer side of the second substrate, wherein

a difference in an amount of angle exists between a pre-tilt angle given by the first orientation film to liquid crystal molecules near the first orientation film and a pre-tilt angle given by the second orientation film to liquid crystal molecules near the second orientation film.

(2) The liquid crystal device according to (1), further comprising:

a stripe-shaped first electrode formed above the surface on the liquid crystal layer side of the first substrate;

a second electrode formed above the surface on the liquid crystal layer side of the second substrate; and

a plurality of lens columns whose refractive indices are each changed by changing orientation directions of the liquid crystal molecules of the liquid crystal layer by a voltage applied between the first electrode and the second electrode.

(3) The liquid crystal device according to (2), wherein the second electrode is a planar electrode or a stripe-shaped electrode formed in a direction orthogonal to a direction in which the first electrode extends.
(4) The liquid crystal device according to (2), further comprising:

a power supply line that supplies power to the first electrode, wherein

the pre-tilt angle of the liquid crystal molecules near the first orientation film is larger than the pre-tilt angle of the liquid crystal molecules near the second orientation film.

(5) An electronic apparatus comprising the liquid crystal device according to claim (1).

The electronic apparatus of the present disclosure includes the above-described liquid crystal device, and corresponds to, for example, a television device, a digital camera, a personal computer, a video camera, a portable electronic apparatus such as a mobile phone, or a portable information terminal.

The liquid crystal device and the electronic apparatus of the present disclosure can eliminate the problem caused by the reverse twist domain, and can suppress the reduction in yield.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A liquid crystal device comprising:
a first substrate that is a transparent substrate;
a second substrate that is a transparent substrate facing the first substrate;
a liquid crystal layer that contains liquid crystal molecules and is provided between the first substrate and the second substrate;
a first orientation film that orients the liquid crystal molecules and is provided above a surface on the liquid crystal layer side of the first substrate; and
a second orientation film that orients the liquid crystal molecules and is provided above a surface on the liquid crystal layer side of the second substrate,
a difference in an amount of angle exists between a pre-tilt angle given by the first orientation film to liquid crystal molecules near the first orientation film and a pre-tilt angle given by the second orientation film to liquid crystal molecules near the second orientation film.

2. The liquid crystal device according to claim 1,
a stripe-shaped first electrode formed above the surface on the liquid crystal layer side of the first substrate,
a second electrode formed above the surface on the liquid crystal layer side of the second substrate, and
a plurality of lens columns whose refractive indices are each changed by changing orientation directions of the liquid crystal molecules of the liquid crystal layer by a voltage applied between the first electrode and the second electrode.

3. The liquid crystal device according to claim 2,
the second electrode is a planar electrode or a stripe-shaped electrode formed in a direction orthogonal to a direction in which the first electrode extends.

4. The liquid crystal device according to claim 2,
a power supply line that supplies power to the first electrode,
the pre-tilt angle of the liquid crystal molecules near the first orientation film is larger than the pre-tilt angle of the liquid crystal molecules near the second orientation film.

5. An electronic apparatus comprising the liquid crystal device according to claim 1.
